(19) United States
(12) Patent Application Publication
(10) Pub. No.: US 2023/0015416 A1
(43) Pub. Date: Jan. 19, 2023

(54) OPTICAL FIBER PROCESSING APPARATUS

(71) Applicant: COMMSCOPE TECHNOLOGIES LLC, Hickory, NC (US)

(72) Inventors: Chuanwu CHEN, Shanghai (CN); Hang LI, Shanghai (CN); Zongsheng LENG, Shanghai (CN); Yongjun YUAN, Shanghai (CN)

(73) Assignee: COMMSCOPE TECHNOLOGIES LLC, Hickory, NC (US)

(21) Appl. No.: 17/758,000

(22) PCT Filed: Dec. 22, 2020
(86) PCT No.: PCT/US2020/066661

§ 371 Date: Jun. 24, 2022

(30) Foreign Application Priority Data
Dec. 24, 2019 (CN) 201911341561.7

(51) Int. Cl. G02B 6/245; G02B 6/25; G02B 6/44; B08B 1/00; B08B 5/02

(52) U.S. Cl. CPC G02B 6/245; G02B 6/25; G02B 6/4471; B08B 1/002; B08B 5/02; B08B 2240/02

(57) ABSTRACT

The present disclosure relates to an optical fiber processing apparatus. The optical fiber processing apparatus comprising: a fixing module for fixing an optical fiber; and a stripping module for stripping layers outside an uncoated bare fiber of the optical fiber, The stripping module may comprise a stripping member which comprises two bodies arranged in parallel. Each body is provided with two or more kinds of blades suitable for stripping different sizes of layers outside the uncoated bare fiber, and each body is configured to be rotatable about its longitudinal axis to select different blades among the two or more kinds of blades, thereby enabling the stripping member to strip two or more sizes of layers outside the uncoated bare fiber.

### CROSS-REFERENCE TO RELATED APPLICATION

This application is being filed on Dec. 22, 2020 as a PCT International Patent Application and claims the benefit of Chinese Patent Application No. 201911341561.7, filed on Dec. 24, 2019, the disclosure of which is incorporated herein by reference in its entirety.

### TECHNICAL FIELD

The present disclosure relates generally to the field of optical fiber processing. More specifically, the present disclosure relates to an optical fiber processing apparatus.

### DESCRIPTION OF RELATED ART

As shown in FIG. 1, a common structure of an optical fiber comprises an uncoated bare fiber 1, a first buffer layer 2 and a second buffer layer 3 surrounding the uncoated bare fiber 1, and a sheath 4 surrounding the second buffer layer 3. A reinforcing layer 5 is usually further provided between the sheath 4 and the second buffer layer 3. The first buffer layer 2 and the second buffer layer 3 usually have different outer diameters. For example, the first buffer layer 2 may have an outer diameter of 250 um, and the second buffer layer 3 may have an outer diameter of 900 um. In some cases, it is necessary to first strip the second buffer layer 3 as well as other layers outside the second buffer layer to expose the first buffer layer 2, and then strip the exposed first buffer layer 2 to expose the uncoated bare fiber 1. However, current optical fiber stripping devices can only strip buffer layer in one size, but they cannot strip buffer layers in two different sizes.

In addition, current fiber stripping devices do not comprise a cleaning function. Therefore, an operator is required to actively and manually clean the exposed uncoated bare fiber. However, the operator sometimes will forget to clean the exposed uncoated bare fiber, which makes it difficult to control the cleaning quality of the uncoated bare fiber.

### SUMMARY OF THE INVENTION

An object of the present disclosure is to address one or more of the above-mentioned and other issues and to achieve additional advantages.

In the first aspect of the present disclosure, an optical fiber processing apparatus is provided. The optical fiber processing apparatus comprises: a fixing module for fixing an optical fiber; and a stripping module for stripping layers outside an uncoated bare fiber of the optical fiber. The stripping module comprises a stripping member which comprises two bodies arranged in parallel. Each body is provided with two or more kinds of blades suitable for stripping different sizes of layers outside the uncoated bare fiber, and each body is configured to be rotatable about its longitudinal axis to select different blades among the two or more kinds of blades, thereby enabling the stripping member to strip two or more sizes of layers outside the uncoated bare fiber.

According to an embodiment of the present disclosure, a cutting blade is further provided on each body, so that the stripping member can further be used to cut a ribbon optical cable comprising a plurality of optical fibers to make ends of the plurality of optical fibers flush.

According to an embodiment of the present disclosure, at least one of the two or more kinds of blades suitable for stripping different sizes of layers outside the uncoated bare fiber can be replaced with a cutting blade, so that the stripping member can further be used to cut a ribbon optical cable comprising a plurality of optical fibers to make ends of the plurality of optical fibers flush.

According to an embodiment of the present disclosure, the two bodies are configured to be able to translate toward and away from each other in a lateral direction and to be able to translate forward and backward in a longitudinal direction.

According to an embodiment of the present disclosure, the stripping member comprises heating elements for heating the blades to thermally strip the optical fiber.

According to an embodiment of the present disclosure, each body comprises a centered cavity, and the heating elements are disposed in the cavity of each body respectively.

According to an embodiment of the present disclosure, the stripping module comprises driving mechanisms for driving each body to rotate respectively, and each driving mechanism comprises a rotor for rotating the body of the stripping member, and the rotor is configured to be rotated by an impact of an injection gas.

According to an embodiment of the present disclosure, the rotor is mounted in two spaced apart bearings to facilitate the rotation of the rotor and the body of the stripping member.

According to an embodiment of the present disclosure, each driving mechanism is configured to inject the injection gas onto a surface of the rotor at an angle to rotate the rotor by an initial angle, and then to rotate the rotor by an additional angle by means of rotating inertia of the rotor and the body of the stripping member.

According to an embodiment of the present disclosure, the rotor comprises a centered cavity, and in the case that the stripping member comprises heating elements, each heating element or a wire connected to each heating element extends through the cavity of the rotor.

According to an embodiment of the present disclosure, the stripping module further comprises cleaning brushes arranged to face each other in a lateral direction, the cleaning brushes being configured to contact and clean the blades in a non-working position when the two bodies of the stripping member translate forward and backward in a longitudinal direction.

According to an embodiment of the present disclosure, the stripping module further comprises a cleaning nozzle disposed above the stripping member, the cleaning nozzle being configured to inject a cleaning gas to clean the blades in a working position.

According to an embodiment of the present disclosure, the fixing module comprises a clamping member for clamping and fixing the optical fiber and a driving member for driving the clamping member to clamp or release the optical fiber.

According to an embodiment of the present disclosure, the clamping member comprises a left clamping arm and a right clamping arm, and each of the left clamping arm and the right clamping arm comprises a clamping portion, and wherein the clamping portion of the left clamping arm is made of a first material, and the clamping portion of the right clamping arm is made of a second material softer than the first material.

According to an embodiment of the present disclosure, the clamping portion of the right clamping arm comprises a recess, and the second material is embedded in the recess.

According to an embodiment of the present disclosure, the first material is a metal and the second material is a rubber.

According to an embodiment of the present disclosure, the optical fiber processing apparatus further comprises a cleaning module for cleaning the uncoated bare fiber that is exposed.

According to an embodiment of the present disclosure, the cleaning module comprises two cleaning tape assemblies arranged to face each other in a lateral direction, and the two cleaning tape assemblies are configured to be able to translate toward and away from each other in a lateral direction and to be able to translate forward and backward in a longitudinal direction.

According to an embodiment of the present disclosure, each cleaning tape assembly comprises a housing and a cleaning tape accommodated in the housing, and wherein the housing is provided with a protrusion, and a portion of the cleaning tape protrudes from the housing under the support of the protrusion to form a cleaning portion.

According to an embodiment of the present disclosure, the housing is provided with a button, and when the button is actuated, the cleaning tape will advance by a predetermined length.

According to an embodiment of the present disclosure, the cleaning module further comprises two clamping assemblies for clamping each cleaning tape assembly respectively, and the two clamping assemblies are arranged on a support plate and can be translated on the support plate toward and away from each other in a lateral direction, so that the cleaning tape assemblies can be translated toward and away from each other in the lateral direction.

According to an embodiment of the present disclosure, the support plate is configured to be able to translate forward and backward in a longitudinal direction, so that the cleaning tape assemblies can be translated forward and backward in the longitudinal direction.

According to an embodiment of the present disclosure, the cleaning module further comprises a driving mechanism for driving the clamping assemblies, and wherein a motion conversion mechanism is provided between the driving mechanism and the clamping assemblies, which is configured to convert a movement of the driving mechanism in a vertical direction into a movement of the clamping assembly in a lateral direction.

According to an embodiment of the present disclosure, the optical fiber processing apparatus further comprises a cleaning agent supply module for supplying a cleaning agent to the cleaning module.

According to an embodiment of the present disclosure, the cleaning agent supply module comprises a container for containing the cleaning agent, pipes for conveying the cleaning agent to the cleaning module, and a control valve for controlling an automatic release of the cleaning agent.

According to an embodiment of the present disclosure, the cleaning agent supply module comprises a pneumatic pump for pumping the cleaning agent in the container.

In the second aspect of the present disclosure, an optical fiber processing apparatus is provided. The optical fiber processing apparatus comprises: a fixing module for fixing an optical fiber; a stripping module for stripping layers outside an uncoated bare fiber of the optical fiber; and a cleaning module for cleaning the uncoated bare fiber that is exposed. The stripping module comprises a stripping member including two or more kinds of blades suitable for stripping different sizes of layers outside the uncoated bare fiber, so that the stripping member can strip two or more sizes of layers outside the uncoated bare fiber. The cleaning module is configured to automatically clean the exposed uncoated bare fiber after the stripping module performs a stripping operation.

According to an embodiment of the present disclosure, the stripping member further comprises a cutting blade, so that the stripping member can further be used to cut a ribbon optical cable comprising a plurality of optical fibers to make ends of the plurality of optical fibers flush.

According to an embodiment of the present disclosure, at least one of the two or more kinds of blades suitable for stripping different sizes of layers outside the uncoated bare fiber can be replaced with a cutting blade, so that the stripping member can further be used to cut a ribbon optical cable comprising a plurality of optical fibers to make ends of the plurality of optical fibers flush.

According to an embodiment of the present disclosure, the stripping member comprises heating elements for heating the blades to thermally strip the optical fiber.

According to an embodiment of the present disclosure, the stripping is member comprises two bodies arranged in parallel, each body is provided with the two or more kinds of blades, and each body is configured to be rotatable about its longitudinal axis to select different blades among the two or more kinds of blades.

According to an embodiment of the present disclosure, the stripping module comprises driving mechanisms for driving each body to rotate respectively, and each driving mechanism comprises a rotor for rotating the body of the stripping member, and the rotor is configured to be rotated by an impact of an injection gas.

According to an embodiment of the present disclosure, each driving mechanism is configured to inject the injection gas onto a surface of the rotor at an angle to rotate the rotor by an initial angle, and then to rotate the rotor by an additional angle by means of rotating inertia of the rotor and the body of the stripping member.

According to an embodiment of the present disclosure, the stripping member comprises only one body, the two or more kinds of blades are disposed on the body in pairs, and each pair of the two or more kinds blades are configured to face each other and to be able to translate toward and away from each other.

According to an embodiment of the present disclosure, the fixing module comprises a clamping member for clamping and fixing the optical fiber, and the clamping member comprises a left clamping arm and a right clamping arm, and wherein each of the left clamping arm and the right clamping arm comprises a clamping portion, and the clamping portion of the left clamping arm is made of a first material, and the clamping portion of the right clamping arm is made of a second material softer than the first material.

According to an embodiment of the present disclosure, the clamping portion of the right clamping arm comprises a recess, and the second material is embedded in the recess.

According to an embodiment of the present disclosure, the cleaning module comprises a cleaning tape assembly including a housing and a cleaning tape accommodated in the housing, and wherein the housing is provided with a protrusion, and a portion of the cleaning tape protrudes from the housing under a support of the protrusion to form a cleaning portion.

According to an embodiment of the present disclosure, the housing is provided with a button, and when the button is actuated, the cleaning tape will advance by a predetermined length.

According to an embodiment of the present disclosure, the cleaning module comprises two cleaning tape assemblies arranged to face each other in a lateral direction, and the two cleaning tape assemblies are configured to be able to translate toward and away from each other in a lateral direction and to be able to translate forward and backward in a longitudinal direction.

According to an embodiment of the present disclosure, the optical fiber processing apparatus further comprises a cleaning agent supply module for supplying a cleaning agent to the cleaning module, and the cleaning agent supply module comprises a container for containing the cleaning agent, pipes for conveying the cleaning agent to the cleaning module, and a control valve for controlling an automatic release of the cleaning agent.

In the third aspect of the present disclosure, an optical fiber processing apparatus is provided. The optical fiber processing apparatus comprises: a fixing module for fixing an optical fiber; and a stripping module for stripping one or more layers outside an uncoated bare fiber of the optical fiber. The stripping module comprises a stripping member comprising one or more blades suitable for stripping one or more layers outside the uncoated bare fiber. The stripping module comprises a cleaning mechanism for cleaning the one or more stripping blades.

According to an embodiment of the present disclosure, the stripping member comprises two bodies arranged in parallel, and the cleaning mechanism comprises cleaning brushes arranged to face each other in a lateral direction, the cleaning brushes being configured to contact and clean the blades in a non-working position when the two bodies of the stripping member translate forward and backward in a longitudinal direction. The cleaning mechanism may further comprise a cleaning nozzle disposed above the stripping member, the cleaning nozzle being configured to inject a cleaning gas to clean the blades in a working position.

According to an embodiment of the present disclosure, the cleaning mechanism comprises a cleaning nozzle disposed above the stripping member, the cleaning nozzle being configured to inject a cleaning gas to clean the blades in a working position.

It is noted that aspects of the present disclosure described with respect to one embodiment may be incorporated in a different embodiment although not specifically described relative thereto. That is, all embodiments and/or features of any embodiment can be combined in any way and/or combination, as long as they do not contradict each other.

### BRIEF DESCRIPTION OF THE DRAWINGS

A plurality of aspects of the present disclosure will be better understood with reference to the following detailed description of the embodiments of the present disclosure in conjunction with the drawings, wherein:

FIG. 1 illustrates a common structure of an optical fiber.

FIG. 2 illustrates an optical fiber processing apparatus according to an embodiment of the present disclosure.

FIG. 3 illustrates a fixing module of the optical fiber processing apparatus according to an embodiment of the present disclosure.

FIG. 4 illustrates a stripping module of the optical fiber processing apparatus according to an embodiment of the present disclosure.

FIG. 5 to FIG. 7 illustrate the details of a stripping member of the stripping module shown in FIG. 4, respectively.

FIG. 8 to FIG. 10 illustrate a cleaning module of the optical fiber processing apparatus according to an embodiment of the present disclosure.

FIG. 11 illustrates a cleaning agent supply module of the optical fiber processing apparatus according to an embodiment of the present disclosure.

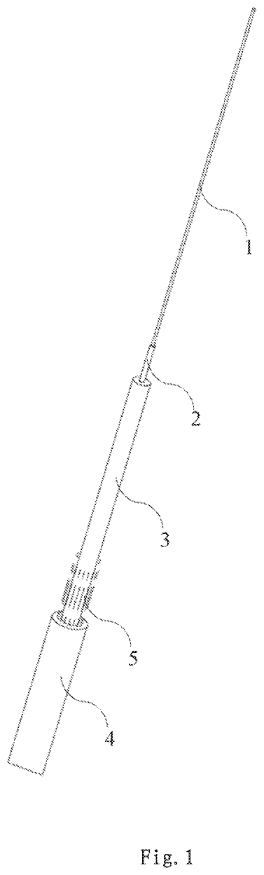

It should be understood that the same reference numerals denote the same elements throughout the drawings. In the drawings, the dimensions of certain features may be changed for clarity without drawing to scale.

### DETAILED DESCRIPTION

The present disclosure will be described below with reference to the drawings, in which several embodiments of the present disclosure are shown. It should be understood, however, that the present invention may be implemented in many different ways and is not limited to the example embodiments described below. In fact, the embodiments described hereinafter are intended to make a more complete disclosure of the present invention and to adequately explain the scope of the present invention to a person skilled in the art. It should also be understood that, the embodiments disclosed herein can be combined in various ways to provide many additional embodiments.

It should be understood that, the wordings in the specification are only used for describing particular embodiments and are not intended to limit the present invention. All the terms used in the specification (including technical and scientific terms) have the meanings as normally understood by a person skilled in the art, unless otherwise defined. For the sake of conciseness and/or clarity, well-known functions or constructions may not be described in detail.

The singular forms “a/an” and “the” as used in the specification, unless clearly indicated, all contain the plural forms. The wordings “comprising”, “containing” and “including” used in the specification indicate the presence of the claimed features, but do not preclude the presence of one or more additional features. The wording “and/or” as used in the specification includes any and all combinations of one or more of the relevant items listed.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, when an element is referred to as being “on”, “attached” to, “connected” to, “coupled” with, “contacting”, etc., another element, it can be directly on, attached to, connected to, coupled with or contacting the other element or intervening elements may also be present.

The terms “first” and “second” as used in the specification are only for ease of description and are not intended to be limiting. Any technical features represented by the terms “first” and “second” are interchangeable.

In the specification, wordings describing spatial relationships such as “up”, “down”, “front”, “back”, “top”, “bottom” and the like may describe a relation of one feature to another feature in the drawings. It should be understood that these terms also encompass different orientations of the apparatus in use or operation, in addition to encompassing the orientations shown in the drawings. For example, when the apparatus in the drawings is turned over, the features previously described as being “below” other features may be described to be “above” other features at this time. The apparatus may also be otherwise oriented (rotated 90 degrees or at other orientations) and the relative spatial relationships will be correspondingly altered.

In the specification, “longitudinal direction” refers to a direction parallel to the length or axial direction of an optical fiber; and “lateral direction” refers to a direction perpendicular to the length or axial direction of the optical fiber as well as the vertical direction.

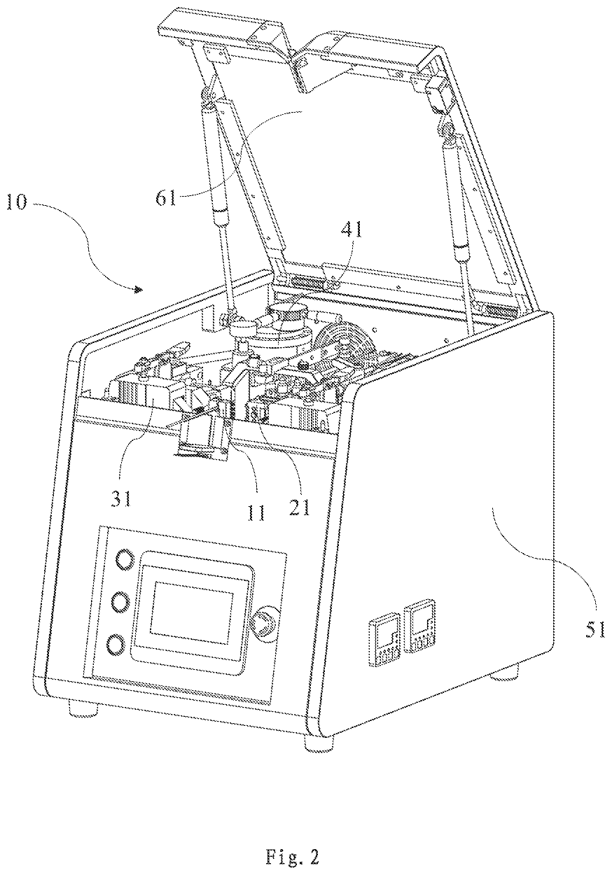

Referring to FIG. 2, an optical fiber processing apparatus 10 according to an embodiment of the present disclosure is shown. The optical fiber processing apparatus 10 may comprise a fixing module 11 for fixing an optical fiber and a stripping module 21 for stripping layers outside the uncoated bare fiber of the optical fiber. The stripping module 21 is configured to strip two or more sizes of layers outside the uncoated bare fiber. The optical fiber processing apparatus 10 may further comprise a cleaning module 31 for cleaning the exposed uncoated bare fiber and a cleaning agent supply module 41 for supplying a cleaning agent to the cleaning module 31. The fixing module 11, the stripping module 21, the cleaning module 31, and the cleaning agent supply module 41 may be arranged in a housing 51 with an appropriate layout. The housing 51 may be closed by a cover 61. The optical fiber processing apparatus 10 may be configured to perform optical fiber stripping and cleaning operations with the cover 61 closing the housing 51, so as to improve the safety of the optical fiber processing apparatus 10. To this end, an induction device may be arranged on the cover 61. The induction device is configured to allow the optical fiber processing apparatus 10 to be activated when it is sensed that the cover 61 is closed, and not allow the optical fiber processing apparatus 10 to be activated when it is sensed that the cover 61 is opened.

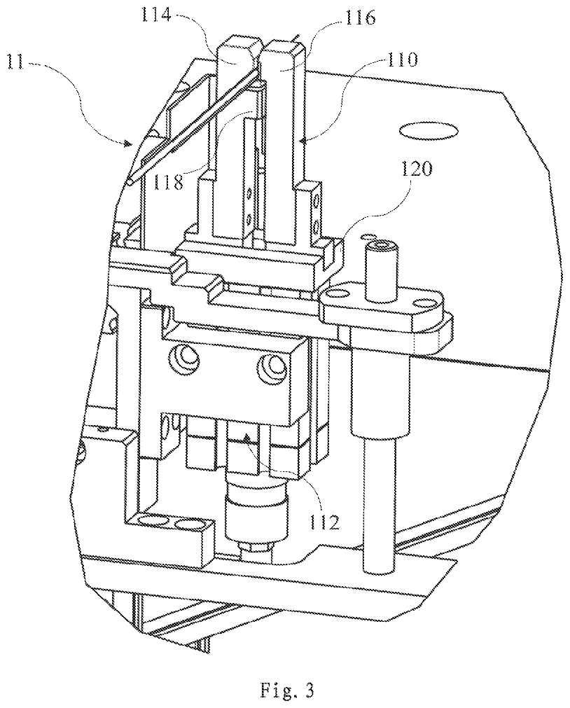

Referring to FIG. 3, the fixing module 11 according to an embodiment of the present disclosure is shown. The fixing module 11 comprises a clamping member 110 for clamping and fixing the optical fiber, and a driving mechanism 112 for driving the clamping member 110 to clamp or release the optical fiber. The clamping member 110 may comprise a left clamping arm 114 and a right clamping arm 116. The left clamping arm 114 and the right clamping arm 116 may move toward or away from each other when driven by the driving mechanism 112, so as to clamp or release the optical fiber. The left clamping arm 114 and the right clamping arm 116 may each comprise a clamping portion. A support portion 118 may be provided below the clamping portion of the left clamping arm 114 to support the optical fiber, so as to prevent the optical fiber from falling down from a gap between the left clamping arm 114 and the right clamping arm 116 during the release process of the optical fiber. According to an embodiment of the present disclosure, the clamping portion of the left clamping arm 114 is made of a first material (such as a metal) which is relatively hard and the clamping portion of the right clamping arm 116 is made of a second material (such as a rubber) softer than the first material, which makes it possible to avoid damaging the optical fiber while maintaining a sufficient clamping force. The clamping portion of the right clamping arm 116 may comprise a recess, and the second material may be embedded in the recess. The left clamping arm 114 and the right clamping arm 116 may be mounted on a base 120 and may translate on the base 120. The driving mechanism 112 may be disposed below the base 120. According to an embodiment of the present disclosure, the driving mechanism 112 may be any suitable type of driving mechanism, such as pneumatic, hydraulic, mechanical, electrical driving mechanisms, and the like.

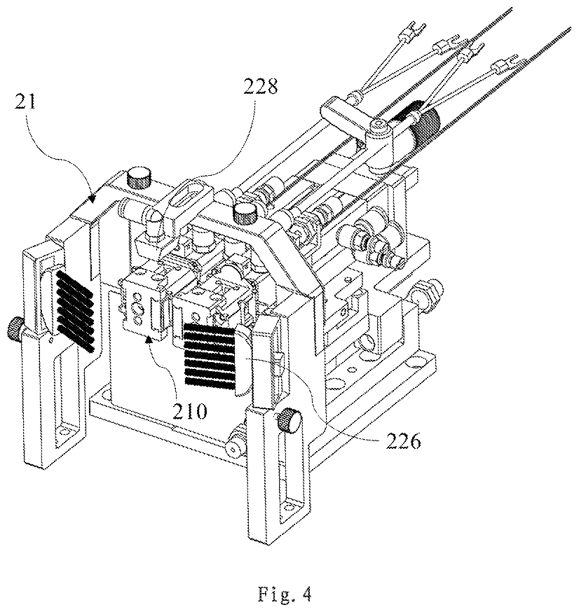

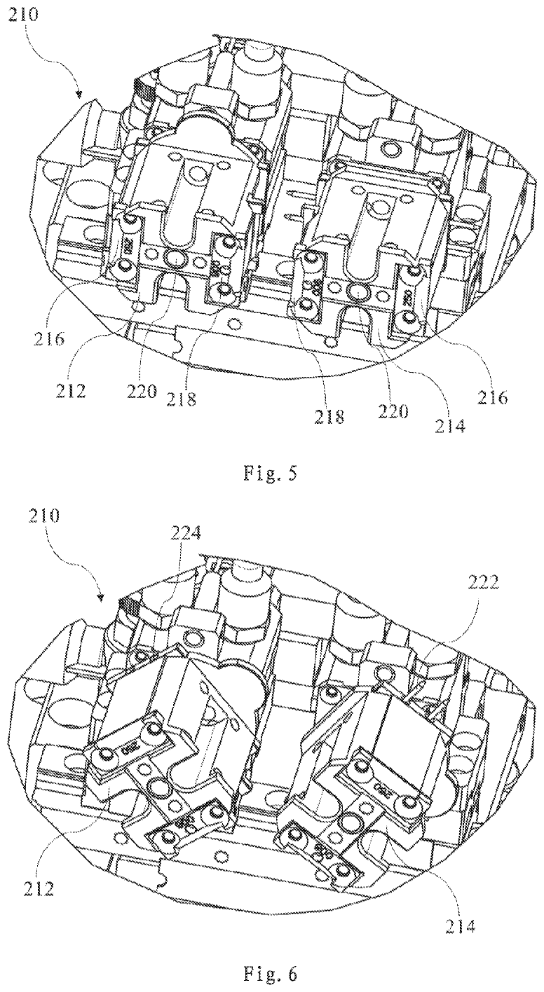

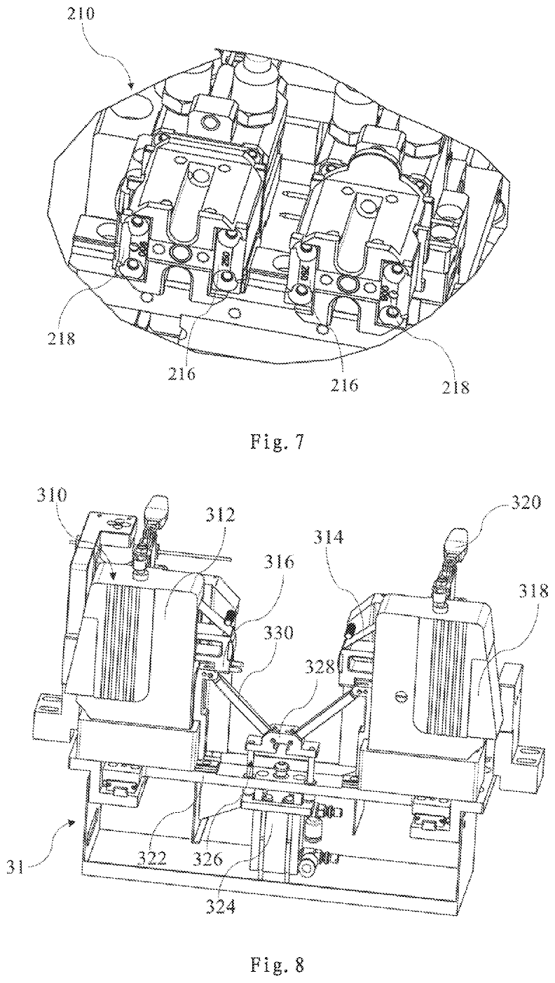

A specific structure of the stripping module 21 according to an embodiment of the present disclosure is described with reference to FIGS. 4 to 7. The stripping module 21 comprises a stripping member 210. The stripping member 210 is configured to strip two or more sizes of layers outside the uncoated bare fiber. Specifically, the stripping member 210 may comprise two bodies 212 and 214 arranged in parallel. Two or more kinds of blades 216 and 218 suitable for stripping different sizes of layers outside the uncoated bare fiber may be provided on each body 212 and 214. The bodies 212 and 214 are configured to be capable of performing translational movements toward and away from each other in a lateral direction, performing translational movements forward and backward in a longitudinal direction, and performing rotational movements about respective longitudinal axes. When it is intended to strip a layer of a first size outside the uncoated bare fiber, the blades of the bodies 212 and 214 that are suitable for stripping the layer of the first size are moved to face each other (as shown in FIG. 5), and the bodies 212 and 214 translate in the lateral direction towards each other to cut the blades into the layer of the first size that is intended to be stripped; then, the bodies 212 and 214 translate backward together in the longitudinal direction to strip the layer of the first size with the blades from the optical fiber. When it is intended to strip layers of other sizes outside the uncoated bare fiber, the bodies 212 and 214 are rotated around their respective longitudinal axes (as shown in FIG. 6), so that the blades of the bodies 212 and 214 that are suitable for stripping the layers of other sizes are moved to face each other (as shown in FIG. 7), and then follow the same steps as stripping the layer of the first size to strip the layers of other sizes.

In the embodiments shown in FIGS. 4 to 7, the bodies 212 and 214 have substantially rectangular cross sections. Two kinds of blades 216 and 218 are arranged on each body 212 and 214, which are arranged on opposite sides of each body 212 and 214, respectively. The blade 216 is suitable for stripping a layer of a first size outside the uncoated bare fiber (for example, a 250 um buffer layer), and the blade 218 is suitable for stripping a layer of a second size different from the first size outside the uncoated bare fiber (for example, a 900 um buffer layer). However, the present disclosure is not limited thereto. More kinds of blades may be arranged on each body 212 and 214 to enable the stripping member 210 to strip more sizes of layers outside the uncoated bare fiber. For example, three or four kinds of blades can be arranged on each body 212 and 214, and each kind of blade is located on a different side of the body 212 or 214, respectively. As needed, the bodies 212 and 214 can also be configured to have other shapes of cross sections (such as pentagons, hexagons, etc.) to facilitate the arrangement of more kinds of blades on the body. By arranging more kinds of blades on the bodies 212 and 214, the functions that the stripping member 210 can achieve may be further expanded, for example, the stripping member 210 may cut optical fibers (for example, by adding a cutting blade) in addition to stripping different sizes of layers outside the uncoated bare fiber of an optical fiber. The ability to cut optical fibers is important for a ribbon cable, since the ribbon cable generally comprises a plurality of optical fibers, ends of which might not be flush due to the optical fibers may have various lengths. Therefore, the ribbon cable may be first cut with the stripping member 210 to make the ends of the optical fibers flush, and then the optical fibers may be stripped. In addition, by arranging more kinds of blades on the bodies 212 and 214, the stripping member 210 may also suitable for stripping different sizes of layers outside the uncoated bare fiber of different kinds of optical fibers, thereby further improving the universality of the optical fiber processing apparatus 10.

In the embodiment in which two kinds of blades 216 and 218 are arranged on each body 212 and 214 as shown in FIGS. 4 to 7, one strip function of the stripping member 210 may be converted into a cutting function by changing one kind of blades. In this way, the stripping member 210 can perform two functions of cutting the optical fiber and stripping one size of layer outside the uncoated bare fiber. In the embodiment in which more kinds of blades are arranged on each body 212 and 214, multiple functions of cutting the optical fiber and stripping various sizes of layers outside the uncoated bare fiber may be realized without changing the blades.

The bodies 212 and 214 may comprise centered cavities 220. Heating elements may be disposed in the cavities 220 to heat the bodies 212 and 214 and the blades 216 and 218, so as to thermally strip the optical fiber. The heating elements may be configured in the form of heating rods. Thermocouples may be arranged at appropriate positions of the bodies 212 and 214 to measure the temperatures of the bodies 212 and 214 and the blades 216 and 218, and the operation of the heating elements is controlled based on the measured temperatures. In addition, the bodies 212 and 214 may further comprise limiting members to limit the relative positions of the bodies 212 and 214 during the stripping operation. As shown in FIGS. 5 to 7, extension posts 222 are provided on a side of the body 214, and holes 224 for receiving the extension posts 222 are provided on a side of the body 212. When the bodies 212 and 214 move toward each other to perform the stripping operation, the extension posts 222 of the body 214 extend into the holes 224 of the body 212 to ensure that the bodies 212 and 214 are aligned with each other and to ensure that the blades on the body 212 and the body 214 are aligned with each other.

According to an embodiment of the present disclosure, the translation of the bodies 212 and 214 of the stripping member 210 may be achieved by one or more driving mechanisms, which may be any suitable type of driving mechanism, such as pneumatic, hydraulic, mechanical, electrical driving mechanisms, and the like. The rotation of each body of the stripping member 210 is achieved by a specific driving mechanism according to an embodiment of the present disclosure. The specific driving mechanism is configured as a pneumatic cylinder including a rotor for rotating the body of the stripping member. One end of the rotor is connected to the body of the stripping member 210. The rotor may be mounted in two spaced apart bearings to facilitate the rotation of the rotor as well as the body of the stripping member 210. According to an embodiment of the present disclosure, the rotor of the pneumatic cylinder is configured to be rotated by the impact of an injection gas. The injection gas can be injected onto a surface of the rotor at an angle to rotate the rotor by an initial angle, and then continue to rotate the rotor by an additional angle by means of the rotational inertia of the rotor and the body of the stripping member 210. This way significantly saves the energy consumed by the pneumatic cylinder when driving the body of the stripping member. In addition, the rotor of the pneumatic cylinder may comprise a centered cavity, such that each heating element provided in the cavity 220 of the body of the stripping member or a wire connected to each heating element may extend through the cavity of the rotor. This facilitates the arrangement of the heating element and its wires.

Returning to FIG. 4, the stripping module 210 may comprise cleaning brushes 226 arranged face each other in a lateral direction and a cleaning nozzle 228 arranged above the stripping member 210 in a central position of the stripping member 210, so as to automatically clean the blades 216 and 218 by brushing the layers outside the uncoated bare fiber which are cut but remained on the blades 216 and 218. The cleaning brushes 226 are fixed to a frame at an appropriate angle, so that the cleaning brushes 226 can contact and clean the blades 216 or 218 in a non-working position when the bodies 212 and 214 are translated forward and backward in the longitudinal direction. The cleaning nozzle 228 can spray a cleaning gas (such as air) to clean the blades 216 or 218 in a working position. By the aid of the cleaning brushes 226 and the cleaning nozzle 228, the residues remained on the blades 216 and 218 (i.e., the layers outside the uncoated bare fiber that have been cut away) can be cleaned in a timely and effective manner, and the cleaning process is also made easier. If the residues remained on the blades 216 and 218 are not cleaned in time, the residues will be cooled down and thus adhere to the blades, which will make cleaning process difficult.

According to other embodiments of the present disclosure, the stripping member 210 may also be configured to comprise only one body. Two or more kinds of blades are disposed on the body in pairs. Each pair of the two or more kinds of blades are configured to face each other and be able to translate toward or away from each other, so that each pair of blades can cut into the layers outside the uncoated bare fiber of the optical fiber or release the optical fiber. The stripping member 210 may be configured to be able to translate forward and backward in the longitudinal direction. When stripping the optical fiber, a pair of the two or more kinds of blades may be translated toward each other to cut into the layers outside the uncoated bare fiber of the optical fiber, and then the stripping member 210 is translated backward in the longitudinal direction to strip the layers outside the uncoated bare fiber.

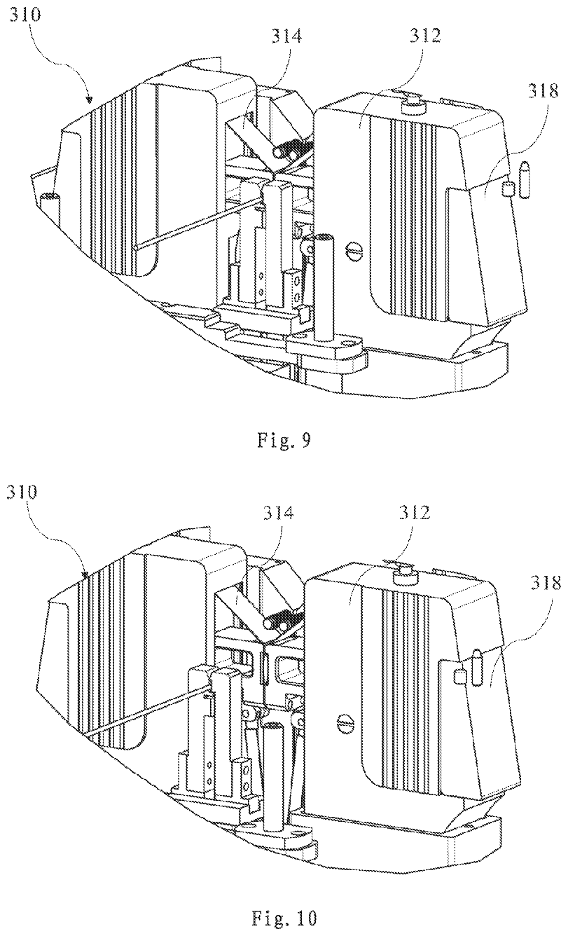

Referring to FIGS. 8 to 10, the cleaning module 31 for cleaning the exposed uncoated bare fiber according to one embodiment of the present disclosure is shown. The cleaning module 31 may be configured to automatically clean the exposed uncoated bare fiber after the stripping module 21 performs a stripping operation. The cleaning module 31 may comprise cleaning tape assemblies 310 arranged facing each other in a lateral direction. Each cleaning tape assembly 310 may comprise a housing 312 and a cleaning tape 314 accommodated in the housing 312. A protrusion 316 is provided on the front side of the housing 312, and the cleaning tape 314 may be wound inside the housing 312 and a portion thereof protrude from the housing 312 under the support of the protrusion 316. The portion of the cleaning tape 314 supported by the protrusion 316 forms a cleaning portion for cleaning the exposed uncoated bare fiber. A button 318 is provided on the back side of the housing 312. When the button 318 is actuated, the cleaning tape 314 will advance by a predetermined length, so that the used portion of the cleaning tape 314 leaves the protrusion 316 and a new portion of the cleaning tape 314 is supported on the protrusion 316 for performing the next cleaning operation.

Similar to the stripping members 210, the cleaning tape assemblies 310 may be configured to be able to translate toward and away from each other in a lateral direction, and forward and backward in a longitudinal direction. After the stripping members 210 strip the optical fiber to expose the uncoated bare fiber, the cleaning tape assemblies 310 are translated toward each other in the lateral direction, so that the cleaning portions of the cleaning tape assemblies 310 sandwich the exposed uncoated bare fiber therebetween. Then, the cleaning tape assemblies 310 are moved backward in the longitudinal direction, so that the portions of the cleaning tapes 314 supported by the protrusions 316 clean the uncoated bare fiber by wiping the exposed uncoated bare fiber. After cleaning the exposed uncoated bare fiber, the cleaning tape assemblies 310 are moved to their initial positions. When the cleaning tape assemblies 310 return to their initial positions, the button 316 of each cleaning tape assembly 310 will be in an actuated state to advance the cleaning tape 314 by a predetermined length, so that a new portion of the cleaning tape 314 is supported on the protrusion 316.

According to an embodiment of the present disclosure, each cleaning tape assembly 310 is clamped on a clamping assembly 320, which facilitates the replacement of the cleaning tape assembly 310. The clamping assemblies 320 are disposed on a support plate 322 and can be translated on the support plate 322 toward and away from each other in a lateral direction, thereby driving the cleaning tape assemblies 310 to be translated toward and away from each other in the lateral direction. The support plate 322 can be translated forward and backward in a longitudinal direction to drive the cleaning tape assemblies 310 fixed thereon to translate forward and backward in the longitudinal direction. The translational movement of the support plate 322 may be driven by one or more driving mechanisms 324 arranged below it. The driving mechanism 324 may be any suitable type of driving mechanism, such as pneumatic, hydraulic, mechanical, electrical driving mechanisms, and the like. According to an embodiment of the present disclosure, a motion conversion mechanism 326 is provided between the driving mechanism 324 and the clamping assemblies 320. The motion conversion mechanism 326 is configured to convert a motion in the vertical direction of the driving mechanism 324 into a translational movement of the clamp assembly 320 and thus the cleaning tape assembly 310 in the lateral direction. Specifically, the motion conversion mechanism 326 comprises an intermediate support 328 and two connecting rods 330. One end of each connecting rod 330 is pivotably connected to the clamping assembly 320, and the other end of each connecting rod 330 is pivotally connected to the intermediate support 328. When the intermediate support 328 moves in the vertical direction under the driving of the driving mechanism 324, the connecting rods 330 can pivotally move under the pushing or pulling of the intermediate support 328, so that the clamping assemblies 320 may move away or toward each other.

By the aid of the cleaning module 31, the uncoated bare fiber can be automatically cleaned each time the optical fiber is stripped, and thus the cleaning quality can be ensured. In addition, the driving mechanism(s) 324 is/are used to move the cleaning tape assemblies 310, which can ensure that the clamping force applied to the uncoated bare fiber is the same each time, and which can ensure the consistency of the cleaning quality.

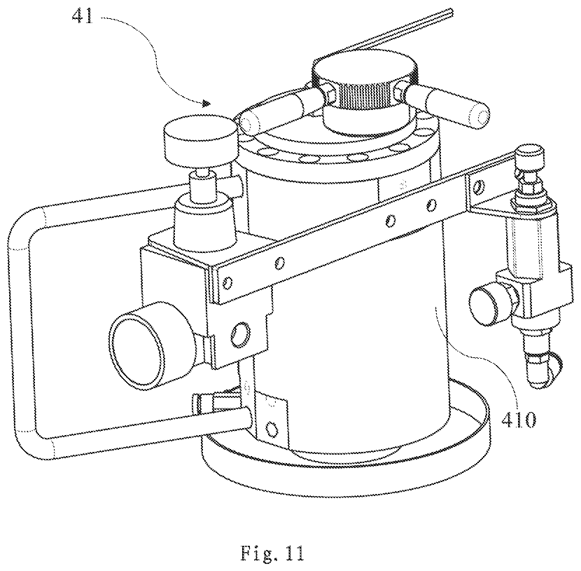

To better clean the uncoated bare fiber, a cleaning agent may also be applied on the cleaning tapes 314. To this end, the optical fiber processing apparatus 10 according to an embodiment of the present disclosure further comprises a cleaning agent supply module 41, which is described with reference to FIG. 11. The cleaning agent supply module 41 comprises a container 410 for containing the cleaning agent, pipes for conveying the cleaning agent to the cleaning module (more specifically, to positions above the portions of cleaning tapes 314 that protrude from the housings of the cleaning tape assemblies), and a control valve for controlling the automatic release of the cleaning agent. The cleaning agent may be dropped from the positions above the cleaning tapes 314 onto the cleaning tapes 314 under the control of the control valve. According to an embodiment of the present disclosure, the cleaning agent in the container 410 may be pumped by a pneumatic pump. The cleaning agent may be alcohol.

According to an embodiment of the present disclosure, a controller may be provided to centrally control operations of the fixing module 11, the stripping module 21, the cleaning module 31, and the cleaning agent supply module 41, thereby realizing the automation of the stripping and cleaning operations. The optical fiber processing apparatus 10 according to the present disclosure can not only strip the layers of different sizes outside the uncoated bare fiber, but also automatically clean the exposed uncoated bare fibers and ensure the cleaning quality of the uncoated bare fibers. Therefore, the processing efficiency and quality of the optical fibers are greatly promoted.

Although exemplary embodiments of this disclosure have been described, those skilled in the art should appreciate that many variations and modifications are possible in the exemplary embodiments without departing from the spirit and scope of the present disclosure. Accordingly, all such variations and modifications are intended to be included within the scope of this disclosure as defined in the claims.

What is claimed is:

1. An optical fiber processing apparatus comprising:
a fixing module for fixing an optical fiber; and
a stripping module for stripping layers outside an uncoated bare fiber of the optical fiber;
wherein the stripping module comprises a stripping member comprising two bodies arranged in parallel, each body is provided with two or more kinds of blades suitable for stripping different sizes of layers outside the uncoated bare fiber, and each body is configured to be rotatable about its longitudinal axis to select different blades among the two or more kinds of blades, thereby enabling the stripping member to strip two or more sizes of layers outside the uncoated bare fiber.

2. The optical fiber processing apparatus according to claim 1, wherein a cutting blade is further provided on each body, so that the stripping member can further be used to cut a ribbon optical cable comprising a plurality of optical fibers to make ends of the plurality of optical fibers flush.

3. The optical fiber processing apparatus according to claim 1, wherein at least one of the two or more kinds of blades suitable for stripping different sizes of layers outside the uncoated bare fiber can be replaced with a cutting blade, so that the stripping member can further be used to cut a ribbon optical cable comprising a plurality of optical fibers to make ends of the plurality of optical fibers flush.

4. The optical fiber processing apparatus according to claim 1, wherein the two bodies are configured to be able to translate toward and away from each other in a lateral direction and to be able to translate forward and backward in a longitudinal direction.

5. The optical fiber processing apparatus according to claim 1, wherein the stripping member comprises heating elements for heating the blades to thermally strip the optical fiber.

6. The optical fiber processing apparatus according to claim 5, wherein each body comprises a centered cavity, and the heating elements are disposed in the cavity of each body respectively.

7. The optical fiber processing apparatus according to claim 1, wherein the stripping module comprises driving mechanisms for driving each body to rotate respectively, and each driving mechanism comprises a rotor for rotating the body of the stripping member, and the rotor is configured to be rotated by an impact of an injection gas.

8. The optical fiber processing apparatus according to claim 7, wherein the rotor is mounted in two spaced apart bearings to facilitate the rotation of the rotor and the body of the stripping member.

9. The optical fiber processing apparatus according to claim 7, wherein each driving mechanism is configured to inject the injection gas onto a surface of the rotor at an angle to rotate the rotor by an initial angle, and then to rotate the rotor by an additional angle by means of rotating inertia of the rotor and the body of the stripping member.

10. The optical fiber processing apparatus according to claim 7, wherein the rotor comprises a centered cavity, and in the case that the stripping member comprises heating elements, each heating element or a wire connected to each heating element extends through the cavity of the rotor.

11. The optical fiber processing apparatus according to claim 1, wherein the stripping module further comprises cleaning brushes arranged to face each other in a lateral direction, the cleaning brushes being configured to contact and clean the blades in a non-working position when the two bodies of the stripping member translate forward and backward in a longitudinal direction.

12. The optical fiber processing apparatus according to claim 1, wherein the stripping module further comprises a cleaning nozzle disposed above the stripping member, the cleaning nozzle being configured to inject a cleaning gas to clean the blades in a working position.

13. The optical fiber processing apparatus according to claim 1, wherein the fixing module comprises a clamping member for clamping and fixing the optical fiber and a driving member for driving the clamping member to clamp or release the optical fiber.

14. The optical fiber processing apparatus according to claim 13, wherein the clamping member comprises a left clamping arm and a right clamping arm, and each of the left clamping arm and the right clamping arm comprises a clamping portion, and wherein the clamping portion of the left clamping arm is made of a first material, and the clamping portion of the right clamping arm is made of a second material softer than the first material.

15. The optical fiber processing apparatus according to claim 14, wherein the clamping portion of the right clamping arm comprises a recess, and the second material is embedded in the recess.

16. The optical fiber processing apparatus according to claim 14, wherein the first material is a metal and the second material is a rubber.

17. The optical fiber processing apparatus according to claim 1, wherein the optical fiber processing apparatus further comprises a cleaning module for cleaning the uncoated bare fiber that is exposed.

18. The optical fiber processing apparatus according to claim 17, wherein the cleaning module comprises two cleaning tape assemblies arranged to face each other in a lateral direction, and the two cleaning tape assemblies are configured to be able to translate toward and away from each other in a lateral direction and to be able to translate forward and backward in a longitudinal direction.

19. The optical fiber processing apparatus according to claim 18, wherein each cleaning tape assembly comprises a housing and a cleaning tape accommodated in the housing, and wherein the housing is provided with a protrusion, and a portion of the cleaning tape protrudes from the housing under the support of the protrusion to form a cleaning portion.

20. The optical fiber processing apparatus according to claim 19, wherein the housing is provided with a button, and when the button is actuated, the cleaning tape will advance by a predetermined length.

21. The optical fiber processing apparatus according to claim 18, wherein the cleaning module further comprises two clamping assemblies for clamping each cleaning tape assembly respectively, and the two clamping assemblies are arranged on a support plate and can be translated on the support plate toward and away from each other in a lateral direction, so that the cleaning tape assemblies can be translated toward and away from each other in the lateral direction.

22. The optical fiber processing apparatus according to claim 21, wherein the support plate is configured to be able to translate forward and backward in a longitudinal direction, so that the cleaning tape assemblies can be translated forward and backward in the longitudinal direction.

23. The optical fiber processing apparatus according to claim 21, wherein the cleaning module further comprises a driving mechanism for driving the clamping assemblies, and wherein a motion conversion mechanism is provided between the driving mechanism and the clamping assemblies, which is configured to convert a movement of the driving mechanism in a vertical direction into a movement of the clamping assembly in a lateral direction.

24. The optical fiber processing apparatus according to claim 17, wherein the optical fiber processing apparatus further comprises a cleaning agent supply module for supplying a cleaning agent to the cleaning module.

25. The optical fiber processing apparatus according to claim 24, wherein the cleaning agent supply module comprises a container for containing the cleaning agent, pipes for conveying the cleaning agent to the cleaning module, and a control valve for controlling an automatic release of the cleaning agent.

26. The optical fiber processing apparatus according to claim 25, wherein the cleaning agent supply module comprises a pneumatic pump for pumping the cleaning agent in the container.

27. An optical fiber processing apparatus comprising:
a fixing module for fixing an optical fiber;
a stripping module for stripping layers outside an uncoated bare fiber of the optical fiber; and
a cleaning module for cleaning the uncoated bare fiber that is exposed;
wherein the stripping module comprises a stripping member including two or more kinds of blades suitable for stripping different sizes of layers outside the uncoated bare fiber, so that the stripping member can strip two or more sizes of layers outside the uncoated bare fiber; and
wherein the cleaning module is configured to automatically clean the exposed uncoated bare fiber after the stripping module performs a stripping operation.

28. The optical fiber processing apparatus according to claim 27, wherein the stripping member further comprises a cutting blade, so that the stripping member can further be used to cut a ribbon optical cable comprising a plurality of optical fibers to make ends of the plurality of optical fibers flush.

29. The optical fiber processing apparatus according to claim 27, wherein at least one of the two or more kinds of blades suitable for stripping different sizes of layers outside the uncoated bare fiber can be replaced with a cutting blade, so that the stripping member can further be used to cut a ribbon optical cable comprising a plurality of optical fibers to make ends of the plurality of optical fibers flush.

30. The optical fiber processing apparatus according to claim 27, wherein the stripping member comprises heating elements for heating the blades to thermally strip the optical fiber.

31. The optical fiber processing apparatus according to claim 27, wherein the stripping member comprises two bodies arranged in parallel, each body is provided with the two or more kinds of blades, and each body is configured to be rotatable about its longitudinal axis to select different blades among the two or more kinds of blades.

32. The optical fiber processing apparatus according to claim 31, wherein the stripping module comprises driving mechanisms for driving each body to rotate respectively, and each driving mechanism comprises a rotor for rotating the body of the stripping member, and the rotor is configured to be rotated by an impact of an injection gas.

33. The optical fiber processing apparatus according to claim 32, wherein each driving mechanism is configured to inject the injection gas onto a surface of the rotor at an angle to rotate the rotor by an initial angle, and then to rotate the rotor by an additional angle by means of rotating inertia of the rotor and the body of the stripping member.

34. The optical fiber processing apparatus according to claim 27, wherein the stripping member comprises only one body, the two or more kinds of blades are disposed on the body in pairs, and each pair of the two or more kinds blades are configured to face each other and to be able to translate toward and away from each other.

35. The optical fiber processing apparatus according to claim 27, wherein the fixing module comprises a clamping member for clamping and fixing the optical fiber, and the clamping member comprises a left clamping arm and a right clamping arm, and wherein each of the left clamping arm and the right clamping arm comprises a clamping portion, and the clamping portion of the left clamping arm is made of a first material, and the clamping portion of the right clamping arm is made of a second material softer than the first material.

36. The optical fiber processing apparatus according to claim 35, wherein the clamping portion of the right clamping arm comprises a recess, and the second material is embedded in the recess.

37. The optical fiber processing apparatus according to claim 27, wherein the cleaning module comprises a cleaning tape assembly including a housing and a cleaning tape accommodated in the housing, and wherein the housing is provided with a protrusion, and a portion of the cleaning tape protrudes from the housing under a support of the protrusion to form a cleaning portion.

38. The optical fiber processing apparatus according to claim 37, wherein the housing is provided with a button, and when the button is actuated, the cleaning tape will advance by a predetermined length.

39. The optical fiber processing apparatus according to claim 37, wherein the cleaning module comprises two cleaning tape assemblies arranged to face each other in a lateral direction, and the two cleaning tape assemblies are configured to be able to translate toward and away from each other in a lateral direction and to be able to translate forward and backward in a longitudinal direction.

40. The optical fiber processing apparatus according to claim 27, wherein the optical fiber processing apparatus further comprises a cleaning agent supply module for supplying a cleaning agent to the cleaning module, and the cleaning agent supply module comprises a container for containing the cleaning agent, pipes for conveying the cleaning agent to the cleaning module, and a control valve for controlling an automatic release of the cleaning agent.

41. An optical fiber processing apparatus comprising:
a fixing module for fixing an optical fiber; and
a stripping module for stripping one or more layers outside an uncoated bare fiber of the optical fiber;
wherein the stripping module comprises a stripping member comprising one or more blades suitable for stripping one or more layers outside the uncoated bare fiber;
wherein the stripping module comprises a cleaning mechanism for cleaning the one or more stripping blades.

42. The optical fiber processing apparatus according to claim 41, wherein the stripping member comprises two bodies arranged in parallel, and the cleaning mechanism comprises cleaning brushes arranged to face each other in a lateral direction, the cleaning brushes being configured to contact and clean the blades in a non-working position when the two bodies of the stripping member translate forward and backward in a longitudinal direction.

43. The optical fiber processing apparatus according to claim 42, wherein the cleaning mechanism further comprises a cleaning nozzle disposed above the stripping member, the cleaning nozzle being configured to inject a cleaning gas to clean the blades in a working position.

44. The optical fiber processing apparatus according to claim 41, wherein the cleaning mechanism comprises a cleaning nozzle disposed above the stripping member, the cleaning nozzle being configured to inject a cleaning gas to clean the blades in a working position.
